(19) United States
(12) Patent Application Publication
(10) Pub. No.: US 2011/0101115 A1
(43) Pub. Date: May 5, 2011

(54) INTERNATIONAL ALPHA-NUMERIC DEMOGRAPHIC IDENTITY CODE

(76) Inventor: CARLYLE RAMPERSAD, Seattle, WA (US)

(21) Appl. No.: 12/938,528

(22) Filed: Nov. 3, 2010

Related U.S. Application Data
(60) Provisional application No. 61/258,426, filed on Nov. 5, 2009.

(51) Int. Cl. G06K 19/06

(52) U.S. Cl. 235/494

(57) ABSTRACT

A universal system and apparatus for the creation, storage, management, manipulation and display of a unique human biometric signature containing both static and dynamic coded information regardless of background or nationality, comprising a user interface to receive data regarding life statistics, a first set of mappings correlating each life statistic with a coded representation for the life statistic, a second set of mappings correlating the coded representation with one of a series of linear positions. Coded life statistics comprise current name, sexual identity, date of birth, country of birth, place of birth, maiden name of the birth mother, name at birth, ethnic and tribal classification, blood type, occupation, country and location of residence. Ethnic classifications are combined from birth parents. Location codes are derived from International Civil Aviation Organization codes. The biometric signature is displayed as an alphanumeric string read from left to right and/or as a two-dimensional barcode.

### CROSS REFERENCE TO RELATED APPLICATION

This application claims priority under 35 USC 119(e) of Provisional Patent Application Ser. No. 61/258,426 filed Nov. 5, 2009, entitled “System for Decentralized Management, Access and Display of Biological Systems-Based Electronic Medical Records,” hereby incorporated by reference in its entirety.

### FIELD OF THE INVENTION

The invention relates to identity codes, namely a universal system and apparatus for the creation, storage, management, manipulation and display of a unique biometric signature containing both static and dynamic coded information for all humans on the earth regardless of background or nationality.

### THE INVENTION

### BACKGROUND OF THE INVENTION

Every service-based institution, service-based industry, and many governmental entities and non-government organizations have instituted a method of identifying persons, clients and/or the patients with whom they interact and serve. Some identification systems are limited to the use of the person's name; some include a person's birth date; others rely solely on Social Security numbers. The identification systems differ, are non-universal, are difficult if not impossible to render secure, and often cannot be shared from one entity to the next.

In the context of the medical field, the lack of universal identification systems causes delays in transfer of patient identification and associated electronic records. As the global community becomes more and more transient, the medical profession is increasingly unable to identify persons within their systems and lacks access to the patient's medical records. It has long been recognized that there is a correlation between a patient's ethnicity/genetic background and their susceptibility to disease (preconditioning). In addition, a patient's pre-existing conditions (allergies, etc.) are critically relevant when making a diagnosis or treatment plan, and rapid transference and immediate availability of this information is vital.

While some countries have adopted nation-wide identification systems, such as the Social Security number used in the United States, many countries have no such systems or are just in the process of adopting a system unique to that country. As a result, the ability to track persons within a country is increasing; however, the systems are not universal, cannot be shared easily among or between nations, and do not allow for accounting for human migration across country borders. Such migration is likely to increase rapidly with the onset of global climate change.

Even the existing advanced biometric code systems, such as fingerprint identification systems, do not take into account recent advances in DNA research. Biologists are finding that the DNA code has certain fixed or static qualities, as well as dynamic qualities relating to age, diet and environment. DNA is increasingly viewed as not only containing genetic code (static), but also containing epigenetic information (dynamic) specific to the person.

Accordingly, there is an urgent, but as of yet unmet, need in the global community for a unique identification system that may be securely utilized universally regardless of language or location, and which can accommodate and capture biometric signatures based on existing, known, as well as future-developed, biological identifiers.

### SUMMARY OF THE INVENTION

The inventive International Alpha-Numeric Demographic Identity Code provides a system and apparatus for the creation, storage, management, manipulation and display of a unique global identity code for every living (and deceased where desired) human on the earth.

The apparatus comprises a user interface to receive data about the human including information regarding specified life statistics. A first set of mappings correlate each of the life statistics with a coded representation for the life statistic. A second set of mappings correlate the coded representation with one of a series of linear positions within the global identity code. A graphics generator prepares a presentation of the global identity code according to the life statistics as coded and correlated to the linear positions selected by the second set of mappings.

The life statistics comprise current name, sexual identity, date of birth, country of birth, place of birth, maiden name of the person's birth mother, name at birth, ethnic and tribal classification, blood type, occupation, country and location of residence, and, where deceased, country and date of death. The coded ethnic/tribal classification comprises two sub-sections. The first sub-section represents the person's ethnic (genetic) background. The second sub-section represents the person's tribal (cultural) background. The ethnic (genetic) classification is represented by a first alpha/numeric ethnic classification of the person's birth mother, and a second alpha/numeric ethnic classification of the person's birth father. The second sub-section for tribal (cultural) classification is represented by alpha/numeric codes reflecting cultures based upon the location of the person's upbringing and cultural background. The life statistics regarding a country and place of birth, and country and place of residence, are coded using International Civil Aviation Organization codes.

The code may be generated and displayed as an alphanumeric string read from left to right and/or as a two-dimensional bar code.

### BRIEF DESCRIPTION OF THE DRAWINGS

The invention is described in more detail with reference to the attached drawings, in which:

FIG. 1 is a global map showing International Civil Aviation Organization country codes; and,

FIGS. 2 through 12 are pictorial representations of fictional persons with their International alpha-Numeric Demographic Identity codes represented alpha-numerically and as a two-dimensional bar code, according to the invention.

### DETAILED DESCRIPTION

The following detailed description illustrates the invention by way of example, not by way of limitation of the scope, equivalents or principles of the invention. This description describes several embodiments, adaptations, variations, alternatives and uses of the invention.

### A. PLURALITY OF SEQUENTIALLY ORDERED ALPHA-NUMERIC CODED SECTIONS

The first and vital step towards rendering all human-related records portable and interoperable within all current institutions throughout the world is to create an electronic identity for each individual. The electronic identity is referred to herein as an International alpha-Numeric Demographic Identity, or “INDI.”

In general terms, the INDI is a biometric signature generated using both static and dynamic parameters specific to the particular person akin to the static nature of DNA code and the dynamic nature of the epigenetic influences on our genetic code. Portions of the INDI are static (remain unchanged) while other portions are dynamic (change over time). Unchanging parameters include, but are not limited to, date of birth, given name at birth, country and place of birth, mother's maiden name, sexual identity, blood type, and ethnicity. Changing parameters include, but are not limited to, occupation and current country and place of residence. The INDI combines the static and dynamic data into a single biometric signature. In addition, as research uncovers new and additional types of biometric identities, the INDI sections may evolve to capture coded information regarding those new biometric identities, as further discussed herein.

The INDI number consists of ten (10) distinct sections. Each section contains a type of information about the individual, from which field identifiers are generated to create an alpha-numeric sequence. Sections 1-8 consist of generally fixed or unchanging information about the individual; Sections 9-10 consist of current information about the person's environment which is subject to change. The sections are summarized as follows:

### Sections 1-8

Section 1 [Initials of Current Name]
Section 2 [Sexual Identity—Genotype]
Section 3 [Date of Birth]
Section 4 [Country and Place of Birth]
Section 5 [Initials of Birth Mother's Maiden Name]
Section 6 [Initials of Given Name at Birth]
Section 7 [Ethnic and Tribal Classification (verified by mDNA code-if known)]
Section 8 [Blood Type]

### Sections 9-10

Section 9 [Occupation]
Section 10 [Bio-Status (Living/Deceased), Current Date/Date of Death, Current Residence City and Country/City and Country of Death]

### B. SYSTEM FOR CODING WITHIN EACH SECTION

Each INDI section has a system for coding one or more particular life statistics. The system for each section of the INDI is summarized as follows:

### Section 1: Initials of Current Name

In Section 1 of the INDI, the person's current name is coded by use of initials. The name is coded as follows: first initial of current surname, followed by first initial of the first name, followed by first initial of the middle name. If the person has no middle name, a zero is entered for that initial. For example, Jean Pierre Kelli is coded as KJP.

### Section 2: Sexual Identity

In Section 2 of the INDI, the person's sexual identity is coded using “X” and/or “Y” to represent the sex chromosomes. A male is represented by the letters XY; a female is represented by the letters XX. For example, Jean Kelli (male) is coded as XY.

### Section 3: Date of Birth

In Section 3 of the INDI, the person's date of birth is represented numerically by the month of birth, followed by the day of birth and the last three numbers of the year. The months are represented as follows: January is 01, February is 02, March is 03, and so on. The days of the month are represented numerically from 01 to 31. The year is represented by three numbers omitting the first number for a given year. For example, 1956 is 956, 2010 is 010, 2110 is 110, 2310 is 310. The date of birth of a fictitious person, Jean Kelli, born on Jan. 24, 1990, is displayed as: 0124990.

### Section 4: Country and Place of Birth

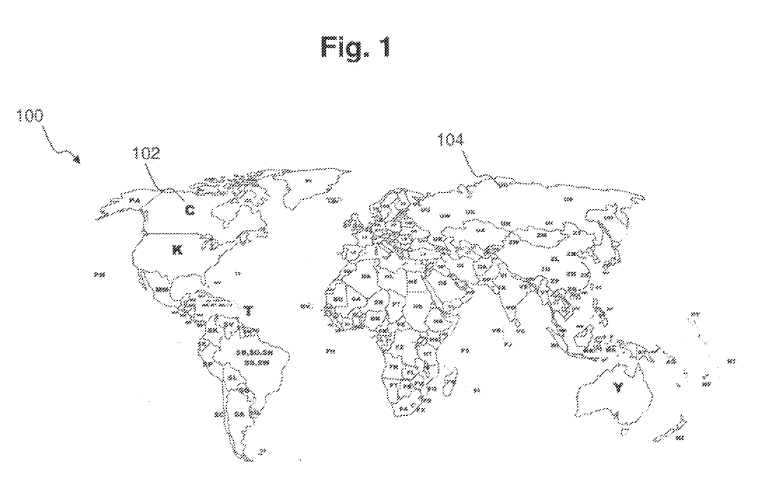

FIG. 1 is a global map showing the outline of countries 100 with unique letter-based International Civil Aviation Organization Aircraft Registration Codes 102/104 (“ICAO code”) assigned to each country. Referring to FIG. 1, the INDI codes for country of birth and place of birth are adopted from the current ICAO codes for country and airport locations.

As shown in FIG. 1, for regions with one country, a single letter is used 102 (for example, the letter “C” for Canada). For regions that contain more than one country, a second letter is added to the code 104. In general, the first letter is allocated by continent and represents a country or group of countries within that continent. The second letter generally represents a country within that region. An additional two codes (not shown) are used to identify each airport within each country. The exception to this rule is larger countries that have single-letter country codes, where the remaining three letters identify the airport.

ICAO codes are set by the International Civil Aviation Organization and are published in ICAO Document 7910: Location Indicators. The ICAO codes are used by air traffic control and airline operations for flight planning. They differ from IATA codes encountered by the general public which are used for airline timetables, reservations and baggage handling. For example, travelers who use London's Heathrow Airport will most likely be familiar with the IATA code: LHR. They are less likely, however, to be familiar with the ICAO code: EGLL. ICAO codes also are used to identify locations such as weather stations, International Flight Service Stations or Area Control Centers, whether or not they are located at airports.

ICAO codes provide geographical context unlike IATA codes. For example, with regard to Heathrow airport, if one knows that the ICAO code for Heathrow is EGLL, then one can deduce that the airport EGNH is located in the UK (it is Blackpool International Airport). On the other hand, knowing that the IATA code for Heathrow is LHR does not enable one to deduce the location of the airport LHV with any greater certainty (it is William T. Piper Memorial Airport in Pennsylvania in the United States).

In the contiguous United States and Canada, most, but not all, airports have been assigned three-letter IATA codes which are the same as their ICAO code without the leading K or C. e.g., YYC and CYYC (Calgary International Airport, Calgary, Alberta), IAD and KIAD (Washington Dulles International Airport, Chantilly, Va.). These codes are not to be confused with radio or television call signs, even though both countries use four-letter call signs starting with those letters. However, because Alaska, Hawaii and United States territories have their own 2-letter ICAO prefix, the situation there is similar to other smaller countries and the ICAO code of their airports is typically different from its corresponding 3-letter FAA/IATA identifier. For example, Hilo International Airport is coded PHTO versus ITO, and Juneau International Airport is coded PAJN versus JNU.

Smaller airports not designated under the ICAO code are assigned codes by each country's respective aviation agency. For example, in the United States, the Federal Aviation Administration has assigned the code F18 to an airport located in Cleburne, Tex. The code for the Cleburne, Tex. airport under the present invention is KF18 (K for U.S.; F18 for Cleburne, Tex.).

Sample ICAO country codes are as follows: A2—Botswana, A3—Tonga, A40—Oman, A5—Bhutan, A6—United Arab Emirates, A7—Qatar, A9—Bahrain, AP—Pakistan, B—China, BT—Taiwan, and BH—Hong Kong, China. Sample ICAO airport codes are as follows: EGKH—Lashenden/Headcorn Airport—Maidstone, England; EGKK (LGW)—London Gatwick Airport—London, England; EGKR (KRH)—Redhill Aerodrome—Redhill, England; EGLA—Bodmin Airfield—Bodmin, England; EGLC (LCY)—London City Airport—London, England.

Thus, for example, using the ICAO codes, the location of the town of Saint Pierre on the French island of Reunion in the Indian Ocean would be represented within the INDI as follows: FR FMEP.

To determine which airport location code should be assigned for an individual's INDI, the inventive system may further comprise an application program for: 1) entry of an individual's residence location data; 2) translation of that data into latitudinal and longitudinal coordinates (“Residence Coordinates”); 3) calculation comparing the Residence Coordinates against the Airport Center Coordinates; 4) determination of the Airport Center Coordinates in closest proximity to the Residence Coordinates; and, 5) calculation and display of the corresponding ICAO and/or country aviation agency code for the closest airport. Referring to Step 1 above, the residence location data entered may be in any suitable or desired form, including, without limitation, a location name (e.g., village name), a physical address, the name of the nearest location (village, town, city), and/or GPS coordinates for the individual's residence.

### Section 5: Initials of Birth Mother's Maiden Name

In Section 5 of the INDI, information about the person's birth mother is coded in the form of initials of the birth mother's maiden name. The initials of a person's mother's maiden name are represented as follows: first letter of her maiden surname followed by first letter of her given first name, followed by the first letter of her given middle name. For example, Helene Marie Bouvier is represented as BHM.

### Section 6: Initials of Given Name at Birth

In Section 6 of the INDI, the initials of a person's given name at birth are represented by the first letter of the person's surname followed by the first letter of the first name, followed by the first letter of the middle name.

### Section 7: Ethnic and Tribal Classifications

Section 7 of the INDI contains coded information about the person's “ethnic” classification (static/DNA based), on the one hand, and a person's “tribal” classification (dynamic/environmental-based), on the other hand. Consequently, the classification comprises two sub-sections. The first sub-section represents the person's ethnic (genetic) background. The second sub-section represents the person's tribal (cultural) background. The two sub-sections combined assist in providing epigenetic information about the person, namely, the impact of a person's environment and culture as related to the person's genetic makeup.

The ethnic (genetic) classification is represented by a first alpha/numeric ethnic classification of the person's birth mother, and a second alpha/numeric ethnic classification of the person's birth father. The second sub-section for tribal (cultural) classification is represented by alpha/numeric codes reflecting cultures based upon the location of the person's upbringing and cultural background.

The ethnic and tribal classifications each comprise a two-position code that can be represented by two letters, two numbers, or a combination of a letter and a number. For the ethnic classification, the first position represents the first position of the mother's ethnic identity; the second position represents the first position of the father's ethnic identity. In a mixed race individual, the two positions are different letters/numbers; in an individual with parents of the same ethnic classification, the two positions are identical letters or numbers. Where the information is unknown for either parent, a zero is entered.

Ethnic (Genetic) Codes

The ethnic codes for the INDI are based on six overall fractional groups derived from mitochondrial DNA in human migratory patterns originating in Africa, namely, Africa, Eastern Europe and the Mediterranean to Northern India, Europe, Asia, Pacific Islander/Australian (Oceania), and America. For each group, subgroups are identified by a two-position alpha and/or numeric code. Exemplary subgroups for Africa and Eastern Europe and Europe are represented as follows:

### Africa

AA—Central and Southern Africans (Peoples of Botswana, Zimbabwe, Lesotho, etc)
ZZ—West and North West Africans
XX—East Africans (Tanzania, etc)
YY—Northeastern Africans (Somalia, Ethiopia, Eritrea, Parts of the Sudan etc)

### Eastern Europe and the Mediterranean to Northern India

EE—North Africans and Middle Easterners (Egypt, Libya, Saudi Arabia, Gulf States)
FF—Peoples of (Persia) Iran, Afghanistan, Pakistan, and extending into Northern India
WW—Turkish, Azerbijan, Turkmenstan
BB—Peoples of Tajikistan, Kazakhstan, Uzbekistan etc.

### Europe

11—Italian
22—Anglo-Saxon (England, Wales)
33—Celtic (Ireland, Scotland)
44—Nordic (Norway, Sweden, Iceland)
55—Finnish (Finland, Lithuania, Estonia, Latvia)
66—Germanic Austrian, Danish, Dutch and the lower countries of Western Europe
77—French
88—Spanish, Portuguese
99—Basque

The first designation of the individual's ethnic classification code is comprised of the first letter or number of the mother's ethnic classification. The second designation is comprised of the first letter or number of the father's ethnic classification.

For example, assuming a person's mother is a combination of a North Eastern African (Somalia YY) mother and a European (French 77) father, the mother's ethnic code will be “Y” from the mother and “7” from the father, or “Y7”. If the person's father is English, Anglo-Saxon on both parents' side, his code is 22. The person's ethnic classification will be “Y2”—the first letter of his mother's code (“Y”) followed by the first number of his father's code (“2”).

As another example, the ethnic coding for a male individual of mixed parents (Mother-Thai—TT, Father-American of German Ancestry-66) is T6. If that individual were to marry an American of Anglo-Saxon/Norwegian heritage, whose code is 24, the ethnic code for the subsequent offspring is 2T—a combination of the first letter of the mother's ethnic classification (“2”) and the first letter of the father's ethnic classification (“T”). The code follows the mother's ethnic classification in the first position because of the significance of the maternal mitochondrial DNA in tracking identity.

While the current ethnic classification is coded based on maternal and paternal ethnic backgrounds, it should be understood that as DNA research continues, and DNA testing becomes more available, Section 7 of the INDI may be expanded to accommodate additional and/or different types of data relating to ethnic origins.

Tribal (Cultural) Codes

The second sub-section of the Ethnic and Tribal Classification is a coded representation of the person's cultural upbringing and background (as opposed to the genetic background). Each Tribal Classification is a one to three letter code. A person may have a single Tribal Classification or multiple Tribal Classifications. The Tribal Classifications include a diaspora of the representative peoples on earth. Examples are as follows:
A—Abzinz—minority in Abkhazia, Karachay-Cherkessia and Adygeya of Russia
AA—Abenaki—Native Americans of Quebec, Vermont, New Hampshire, Maine and Nova Scotia
AB—Abipones—an ethnic minority in Argentina
AC—Abkhaz—minority ethnic group in Georgia, Turkey, Russia and Abkhazia
AD—Aborigines—indigenous peoples of mainland Australia
ABJ—Ak Chin—Native American group now resident in Pinal County, Arizona on the Tohono O'odham Reservation

### Section 8: Blood Type

Section 8 of the INDI contains coded information regarding the person's blood type. The blood types are represented as follows: A positive by the number 1, B positive by the number 2, AB positive by the number 3, O positive by the number 4, A negative by the number 5, B negative by the number 6, AB negative by the number 7, O negative by the number 8. If the blood type is unknown, the field is assigned the numeral zero. In the event new blood types or other blood identifiers are discovered through future research, Section 8 may be expanded to accommodate additional codes to represent the findings.

### Section 9: Occupation

Section 9 of the INDI contains a code representing the person's current occupation. Occupation codes are assigned among 35 categories. The first position in the occupation code is a letter or number indicating the overall field of occupation. Examples are as follows: the letter “A” for arts and entertainment, including artists, actors, musicians, writers; the letter “B” for banking and finance related occupations; the letter “C” for management and administrative related occupations; the letter “D” for distribution, sales and purchasing related occupations; the letter “E” for education and research related occupations; and, the letter “F” for farming, fishing, ranching, and hunting related occupations.

The second and any additional positions of the occupation code constitute a letter or number representing a sub-field or field of specialty within the occupation. For example, under the occupation of Engineering (represented by the letter “N”), the sub-specialties include Aerospace A, Agricultural B, Automotive C, Biomedical D, Chemical E, and Civil F. Consequently, a person with the occupation code of “NA” would be an Aerospace Engineer; a person with the occupation code of “NE” would be a Chemical Engineer.

### Section 10: Bio-Status (Living/Deceased), Current Date/Date of Death, Current Residence City and Country/City and Country of Death

The final section of the INDI provides coded information indicating whether the person is living or deceased. If living, the code “L” is assigned along with the current date in the same manner as for Section 3, supra. Following the date, the location of the person's current residence (city and country) is coded using the same ICAO codes as utilized for Section 4, supra.

Conversely, if the person is deceased, the code “D” is assigned along with the date of death (in the same manner as Section 3, supra), and the location (city and country) where the person died (in the same manner as Section 4, supra).

### C. EXEMPLARY INDIS

For purposes of generating exemplary INDIs, the following fictional persons are presented.

Jean Pierre Kelli—Professional Canadian Skier

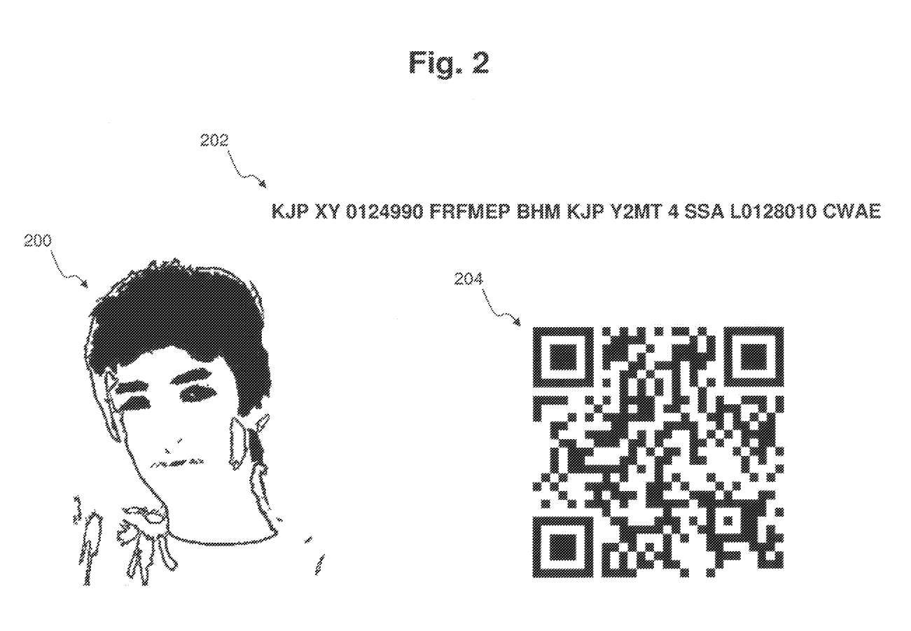

Referring to FIG. 2, a pictorial representation of the fictional Jean Pierre Kelli 200 is shown. Mr. Kelli 200 is a young man, born on Jan. 24, 1990 in the town of Saint Pierre on the French island of Reunion in the Indian Ocean, to Helene Marie Bouvier. His given name at birth is Jean Pierre Kelli. His mother, Helene, is of East African descent and belongs to the Malagasi tribe of Madagascar. Helene's mother was from Somalia and her father was from England and has an Anglo-Saxon ethnicity. Helene's husband (and the father of Jean Pierre) is from France, but his mother was from England. Jean Kelli has a common Blood type of O positive and currently lives in Whistler, British Columbia, Canada, where he is a professional skier.

Referring to FIG. 2, all of the above information is reflected in an INDI 202 for this fictional person. The INDI 202 is shown generated and displayed as a string of alpha-numeric letters and numbers.

Referring to the INDI 202 shown in FIG. 2, and reading the code from left to right, each section contains coded information as follows. Section 1 contains the letters “KJP” for Mr. Kelli's current initials. Section 2 contains the letters “XY” for male genotype. Section 3 contains the numbers “0124990” representing a date of birth of Jan. 24, 1990. Section 4 contains the letters “FRFMEP” representing the ICAO code closest in proximity to his location of birth—Saint Pierre on Reunion Island. Section 5 contains the letters “BHM” for his mother's maiden name of Helene Marie Bouvier. Section 6 contains the letters “KJP” representing Mr. Kelli's initials at birth. Section 7 contains “Y2MT”. The combination “Y2” represents the first position of the ethnic classification of Mr. Kelli's mother (“Y”) and the first position of the ethnic classification of Mr. Kelli's father (“2”). The combination “MT” represents Mr. Kelli's cultural background of the Malagasi Tribe of Madagascar, his mother's tribe. Section 8 represents Mr. Kelli's blood type by the number “4” for O-positive. Section 9 represents Mr. Kelli's occupation by the letters “SSA”—the first letter “S” is for a sport-related occupation, the second letter “S” represents the sub-specialty of skiing; the third letter “A” represents a professional athlete. Section 10 contains the letter “L” for living, followed by the date the information was entered/last updated and the letters “CWAE” representing the ICAO code closest in proximity to Mr. Kelli's current residence, namely, Whistler, British Columbia, Canada.

Referring again to FIG. 2, the same information contained in the INDI 202 is shown coded for privacy in the form of a case sensitive two-dimensional barcode 204. Barcodes represent data in an optical, machine-readable format. Barcodes are typically linear or one-dimensional symbologies. However, barcodes may also take on the form of shapes, such as squares or hexagons. These two-dimensional or matrix symbologies are made of symbols rather than bars. The barcode 204 shown in FIG. 2 is a Quick Response (“QR”) Code readable by QR scanners, typically incorporated into mobile phones with a camera or smartphones. The code 204 comprises black shapes arranged in a square-shaped pattern on a white background. The coded information may be alpha-numeric or other types and forms of data.

Nelson Pachua Pivane—Hopi Indian

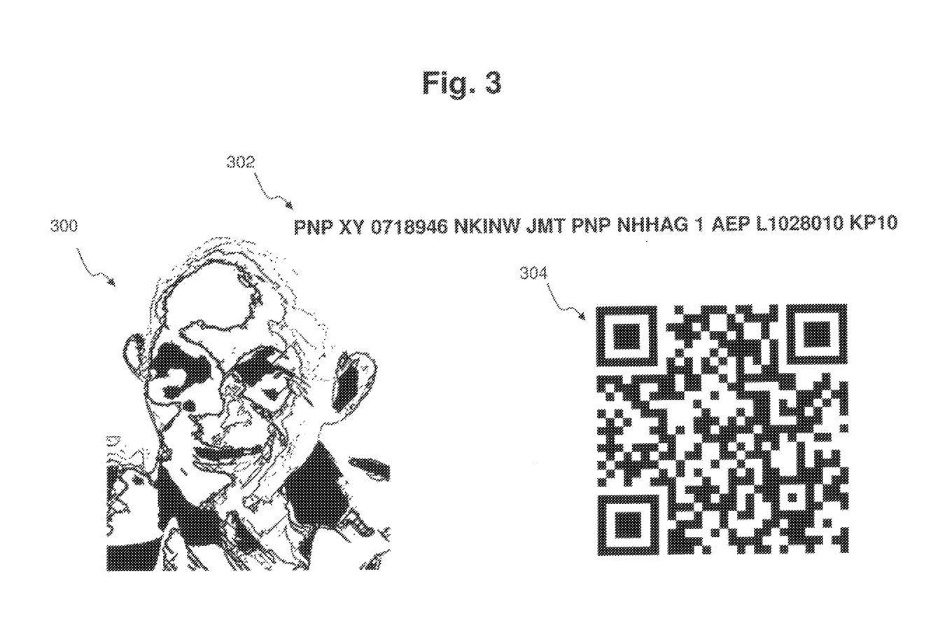

Referring to FIG. 3, an outline of the fictional Nelson Pachua Pivane 300 is shown. Mr. Pivane 300 was born on Jul. 18, 1946 in Winslow, Ariz., USA, to Mariam Tohopka James. His given name at birth was Nelson Pachua Pivane. His mother was a U.S. native Indian; his father was of mixed Hispanic descent. He was raised by his mother as a Hopi Indian of the southwest USA. His blood type is A positive. His occupation has been in the arts, entertainment, and education, most recently as a pottery instructor. Mr. Pivane currently lives in Kerns Canyon, Ariz. (USA).

Referring to FIG. 3, all of the above information is reflected in the INDI for Mr. Pivane as shown both as a string of alpha-numeric letters and numbers 302 and as a two-dimensional barcode 304. Referring to FIG. 3, reading from left to right, the INDI 302 contains coded information for each section as follows. Section 1 contains the letters “PNP” for Mr. Pivane's initials. Section 2 contains the letters “XY” for male genotype. Section 3 contains the numbers “0718946” representing a date of birth of Jul. 18, 1946. Section 4 contains the letters “NKINW” representing the ICAO code closest in proximity to his location of birth—Winslow, Ariz., USA. Section 5 contains the letters “JMT” for his mother's maiden name. Section 6 contains the letters “PNP” representing Mr. Pivane's initials at birth.

Section 7 contains “NH HAG”. The combination “NH” represents the first position of the ethnic classification of Mr. Pivane's mother (“N” from “NN” for native American indian) and the first position of the ethnic classification of Mr. Pivane's (“H” from “HH” for mixed Hispanic descent). The tribal code of “HAG” represents the Hopi Indian tribe of southwestern United States.

Section 8 represents Mr. Pivane's A positive blood type by the number “1”. Section 9 represents Mr. Pivane's occupation by the letters “AEP”—the first letter “A” is for an arts and entertainment-related occupation, the second letter “E” represents the sub-specialty of educator; the third letter “P” represents a pottery instructor. Section 10 contains the letter “L” for living, followed by the current date (Oct. 28, 2010) and the ICAO code of KP10 for his city and country of residence in Kerns Canyon, Ariz., United States.

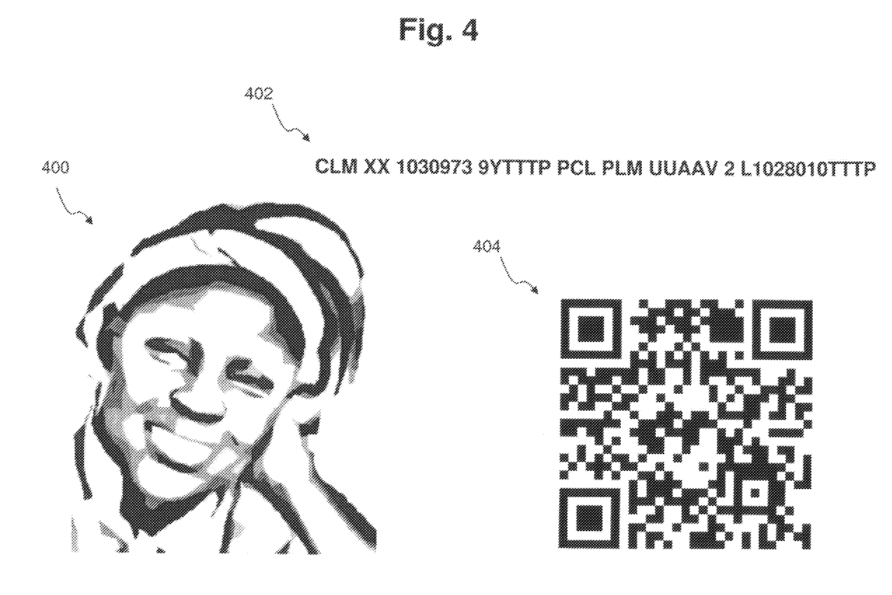

The global application of the INDI system and apparatus is apparent upon examination of other fictional persons as represented in FIGS. 4 through 12. The persons, along with their coded life statistics, are summarized below.

Lorna May Cartwright—Afro-Caribbeanner

Referring to FIG. 4, the INDI code 402 and bar code 404 reflect the following life statistic information for an Afro-Caribbean woman 400:
Name: Lorna May Cartwright (CLM)
Sex: Female (XX)
Date of Birth: 30 Oct. 1973 (1030973)
Country of Birth: Trinidad and Tobago (9Y)
City of Birth: Spring Vale, Claxton Bay (TTTP)
Mothers' Maiden Name: Charmaine Louise Penco (PCL)
Given Name at Birth: Lorna May Penco (PLM)
Genetic Ethnic Classification—Genome Mother Afro Caribbean of Undetermined ancestry (UU))
Father Afro Caribbean of Undetermined Ancestry (UU)=(UU)
Cultural Ethnic Classification—Epi-Genome Afro Trinidadian (AAV)
Blood Type: B Positive (2)
Job Classification: Head Chef in a private hospital (HM2)
Current Residence Current Date and Country and City (ICAO) Living (L) 28 Oct. 2010 St James Port of Spain, Trinidad (1028010TTTP)

Antonio Joseph Melchiorrie—Deceased Italian American

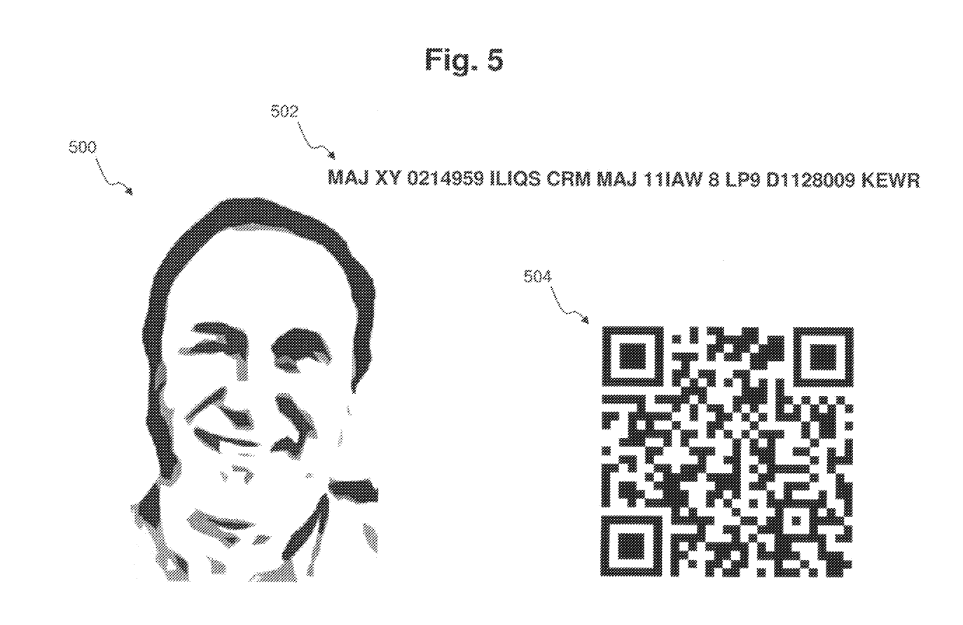

Referring to FIG. 5, the INDI code 502 and bar code 504 reflect the following life statistic information for a deceased Italian American man 500:
Name: Antonio Joseph Melchiorrie (MAJ)
Sex: XY
Date of Birth: Feb. 14, 1959 (0214959)
Country of Birth: Italy (I)
City of Birth: Siena in Tuscany (LIQS)
Mothers' Maiden Name: Rosaria Marie Carrocia (CRM)
Given Name at Birth: Antonio Joseph Melchiorrie (MAJ)
Genetic Ethnic Classification—Genome: Mother Italian, Father Italian (11)
Cultural Ethnic Classification—Epi-Genome [Italian American] (IAW)
Blood Type: O Negative (8)
Job Classification Lawyer State (New Jersey)—Personal Injury Private Practice (LP9)
Deceased (D) Date and Country and City 28 Nov. 2009, Newark, N.J. (1128009 KEWR)

Bashir Hassan Zafar—Iranian

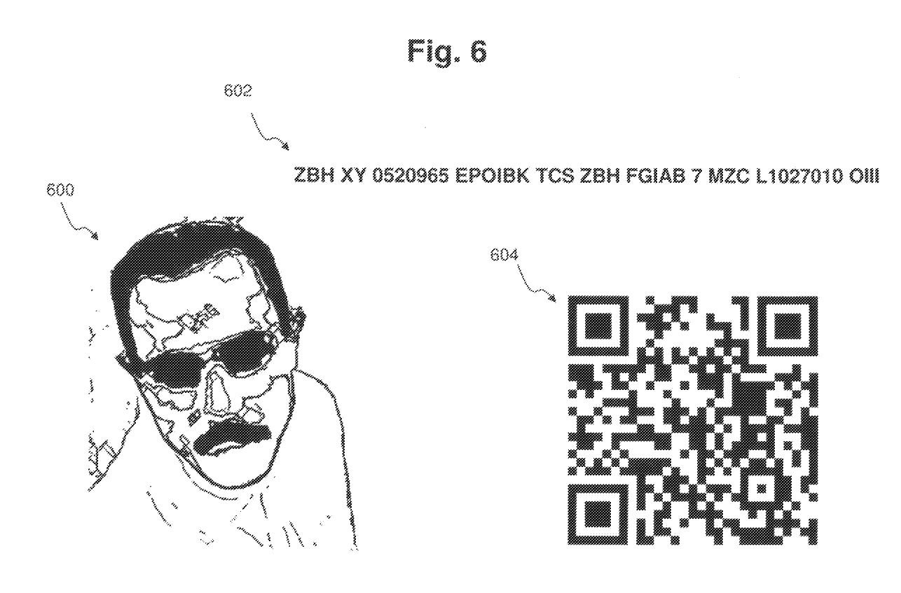

Referring to FIG. 6, the following life statistics for an Iranian male physician 600 are contained within the INDI code 602 and associated bar code 604:
Name: Bashir Hassan Zafar (ZBH)
Sex: Male (XY)
Date of Birth; May 20, 1965
Country of Birth: Iran (EP)
City of Birth: Kish Island Persian Gulf (OIBK)
Mothers' Maiden Name: Chehreh Sarbar Tannaz
Given Name at Birth: Bashir Hassan Zafar
Genetic Ethnic Classification—Genome Mother Iranian (FF), Father Arab Lebanese (GG)=(FG)
Cultural Ethnic Classification—Epi-Genome Iranian-Aryan (IAB)
Blood Type: AB Negative (7)
Job Classification Medical Doctor Cardiac Surgeon (MZC)
Current Residence Current Date and Country and City (ICAO) Living (L) 27 Oct. 2010 Iran Tehran (L1027010 OIII)

Juliano Frei Robeval—Brazilian

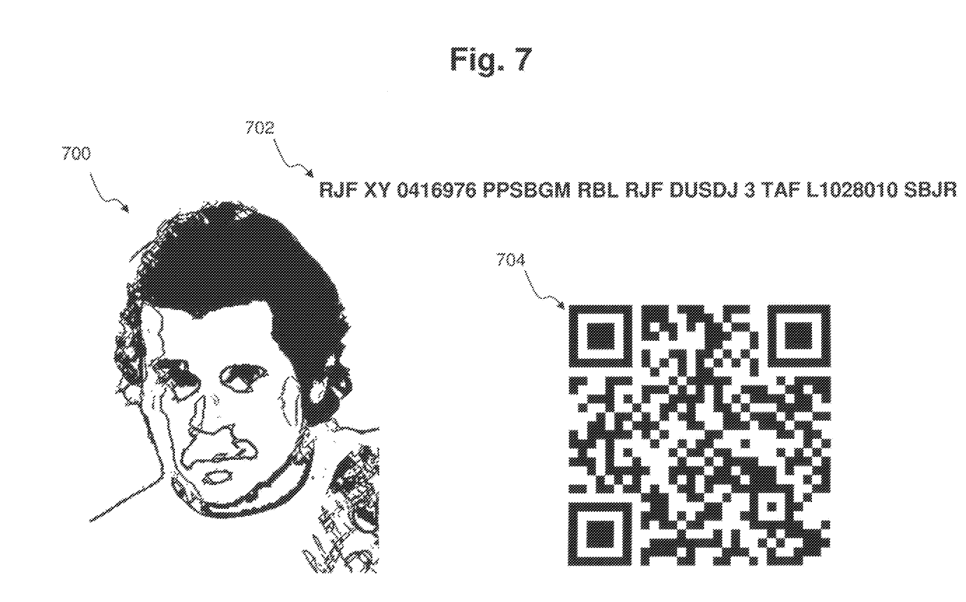

Referring to FIG. 7, the INDI code 702 and associated barcode 704 contain the following information for a Brazilian man 700:
Name: Juliano Frei Robeval (RJF)
Sex: Male (XY)
Date of Birth: 16 Apr. 1976 (0416976)
Place of Birth: Brazil (PP)
City of Birth: Guajara-Mirim, Sao Paulo (SBGM)
Mothers' Maiden Name: Benedita Luisa Renaldo (RBL)
Given Name at Birth: Juliano Frei Robeval (RJF)
Genetic Ethnic Classification—Genome Mother Native Indian (DD) Father African of Undetermined Mixed Ancestry (UU)=(DU)
Cultural Ethnic Classification—Epi-Genome Mother Suva Indian of Brazil (SDJ)
Blood Type: AB Positive (3)
Job Classification: Transportation Aviation Flight Attendant (TAF)
Current Residence Current Date and Country and City (ICAO) Living (L) 28 Oct. 2010 Jacarepagua, Rio de Janeiro, Brazil (SBJR)

Megan Jane Wallace—Australian

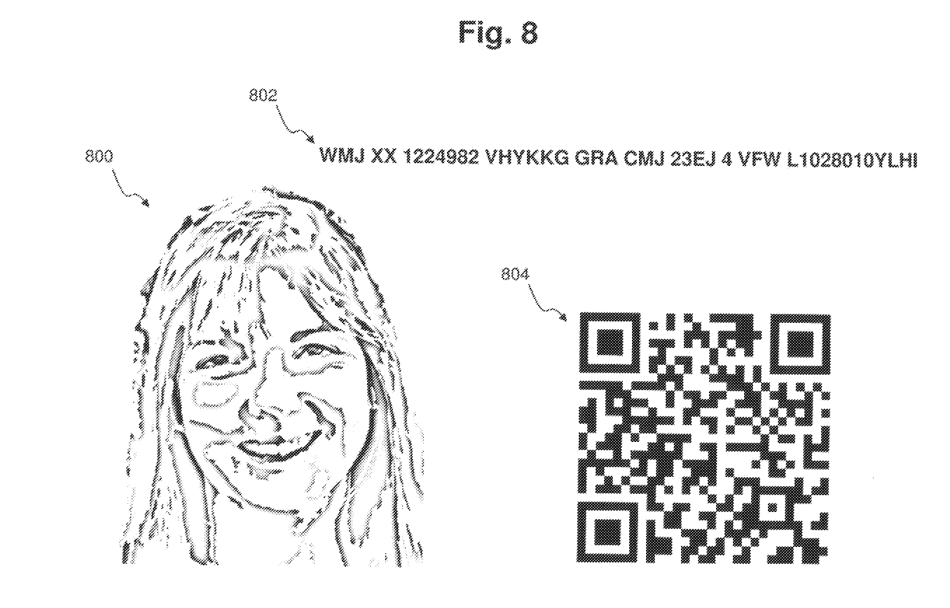

Referring to FIG. 8, the INDI code 802 and associated bar code 804 contain the following information for an Australian woman 800:
Name: Megan Jane Wallace (WMJ)
Sex: Female (XX)
Date of Birth: 24 Dec. 1982 (1224982)
Country of Birth: Australia (VH)
City of Birth; Kalkaringi, Northern Territory (YKKG)
Mothers' Maiden Name: Rosemary Anne Godfrey (GRA)
Given Name at Birth: Megan Jane Campbell (CMJ)
Genetic Ethnic Classification—Genome: Mother Anglo-Saxon English Ancestry (22) Father Celtic-Scotland (33)=23
Cultural Ethnic Classification—Epi-Genome Mother English Australian (EJ) Blood Type: O Positive (4)
Job Classification: Veterinary Medicine Park Ranger Wild Life (VFW)
Current Residence Current Date and Country and City (ICAO) Living (L) 28 Oct. 2010 Lord Howe Island, New South Wales (L1028010YLHI)

Gillian Me-Li Petersen—Adopted Chinese-American

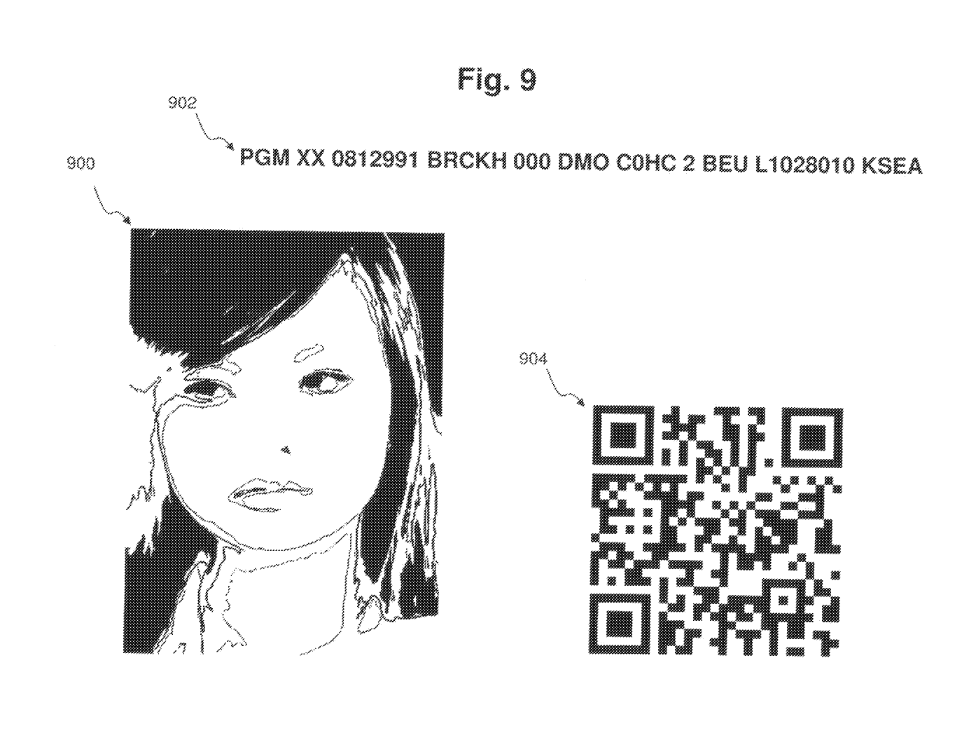

Referring to FIG. 9, the INDI code 902 and barcode 904 contain the following information for an adopted Chinese-American teenage girl:
Name: Gillian Me-Li Petersen (PGM)
Sex: Female (XX)
Date of Birth: 12 Aug. 1991 (0812991)
Country of Birth: China: (B)
City of Birth: Kaosiung City (RCKH)
Mothers' Maiden Name: Name Unknown (0)=(000)
Given Name at Birth: Mei-Li Da-Quan, (by the orphanage) Middle Name Unknown (0)=(DM0)
Genetic Ethnic Classification—Genome Mother Mainland Chinese (CC)
Father Unknown (00)=C0
Cultural Ethnic Classification—Epi-Genome Mother Hakka, a distinct subgroup of Han Chinese of the People's Republic of China and Taiwan=(HC)
Blood Type: B Positive (2)
Job Classification: University Student studying Banking and Finance (BEU)
Current Residence Current Date and Country and City (ICAO) Living (L) 28 Oct. 2010 Seattle, Wash. USA (L1028010) KSEA

Mikhail Serosha Vasiliev—Ukrainian

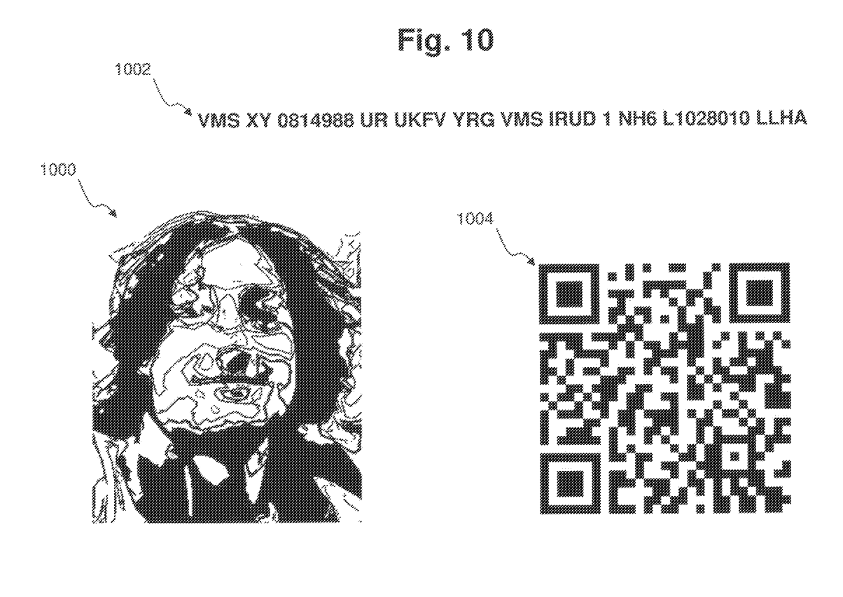

Referring to FIG. 10, the INDI code 1002 and barcode 1004 contain the following information for a Ukrainian male residing in Israel:
Name: Mikhail Serosha Vasiliev (VMS)
Sex: Male (XY)
Date of Birth: 14 Aug. 1988 (0814988)
Country of Birth: Ukraine (UR)
City of Birth: Yevpatoriya (UKFV)
Mothers' Maiden Name: Raisa Galina Yakob (YRG)
Given Name at Birth: Mikhail Serosha Vasiliev (VMS)
Genetic Ethnic Classification—Genome Mother Jewish (II), Father Western Russian (RR)=(IR)
Cultural Ethnic Classification—Epi-Genome Mother Ukrainian (UD)
Blood Type: A Positive (1)
Job Classification: Engineering Computer Software Programmer (NH6)
Current Residence Current Date and Country and City (ICAO) Living (L) 28 Oct. 2010 (L1028010) Haifa Israel. (LLHA)

Morgan Elizabeth Stanton—American Child

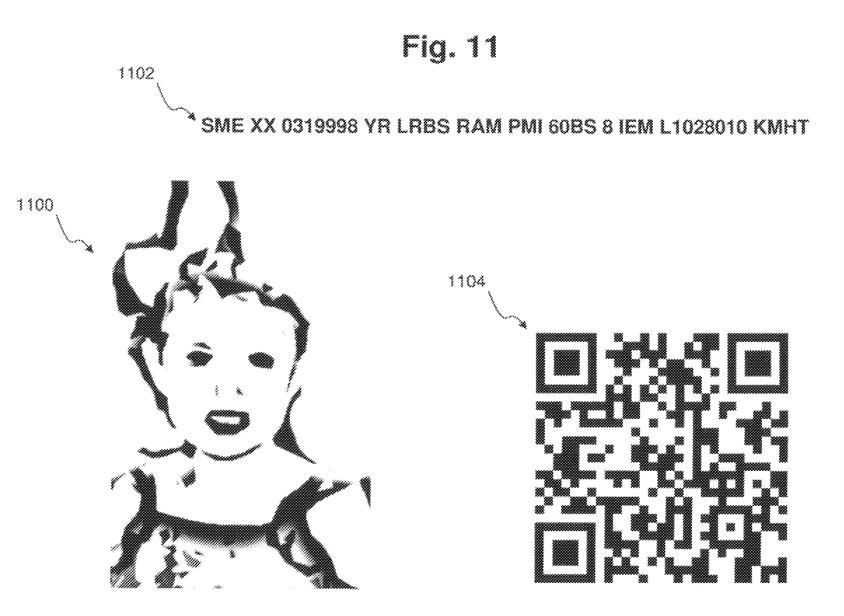

Referring to FIG. 11, the INDI code 1102 and barcode 1104 contain the following information for an American girl:
Name: Morgan Elizabeth Stanton (SME)
Sex: Female (XX)
Date of Birth: 19 Mar. 1998 (0319998)
Country of Birth: Romania: (YR)
City of Birth: Bucharest (LRBS)
Mothers' Maiden Name: Anastasia Madalina Razvan (RAM)
Given Name at Birth: Melita Ihrin Pereteanu (PMI)
Genetic Ethnic Classification—Genome Mother Combination of German mother and Slavic Father (6S)
Father Unknown (00)=60
Cultural Ethnic Classification—Epi-Genome Mother Romanian of German origin—Banat Swabian (BS)
Blood Type: O Negative (8)
Job Classification: Infant Education Middle School Student (IEM)
Current Residence Current Date and Country and City (ICAO) Living (L) 28 Oct. 2010 Londonderry, N.H. USA (L1028010) KMHT

Ty Hiroshi Jackson—Asian American

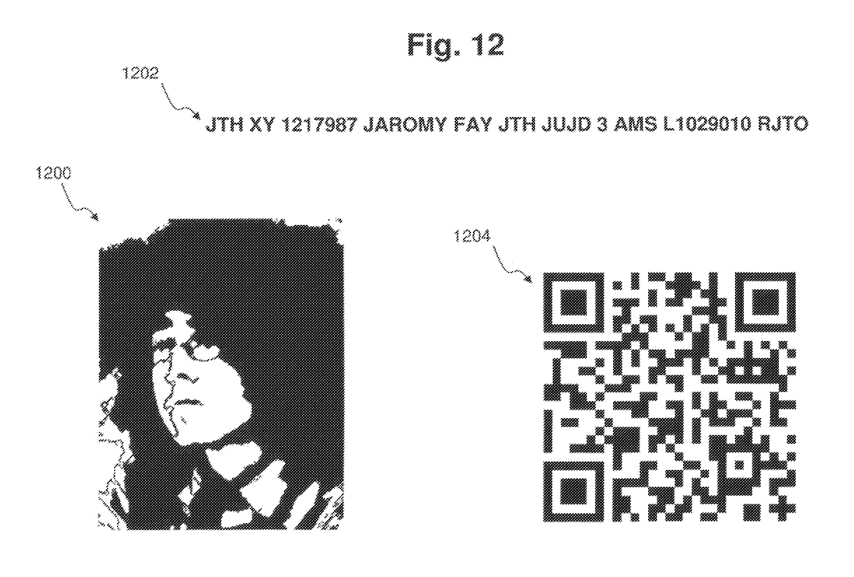

Referring to FIG. 12, the INDI code 1202 and barcode 1204 contain the following information for an Asian American 1200:
Name: Ty Hiroshi Jackson (JTH)
Sex: Male (XY)
Date of Birth: 17 Dec. 1987 (1217987)
Country of Birth: Japan (JA)
City of Birth: Miyakojima, Okinawa (ROMY)
Mothers' Maiden Name: Aiko Yoji Fujita (FAY)
Given Name at Birth: Ty Hiroshi Jackson (JTH)
Genetic Ethnic Classification—Genome Mother Japanese (JJ) Father African American of undetermined ancestry (UU)=(JU)
Cultural Ethnic Classification—Epi-Genome Mother Yamato people (JD)
Blood Type: AB positive (3)
Job Classification: Cello Player Tokyo Symphony—Arts and Entertainment Musician Stringed Instrument (AMS)
Current Residence Current Date and Country and City (ICAO) Living (L) 28 Oct. 2010 in Tokyo, Japan (L1028010) Oshima, Tokyo (RJTO)

### D. SECURITY

The INDI may be secured through any suitable or desired means of encryption, including without limitation devices and associated software applications capable of: 1) symmetric cryptography with password or biometric access; 2) asymmetric cryptography with password or biometric access; 3) hashing with password or biometric access; 4) biometric identification, including without limitation, utilization of fingerprints, iris, retina, finger geometry, voice, facial proportions, and/or hand geometry.

### E. METHOD OF OPERATION

The life statistics for the INDI for a particular person may be acquired in any suitable or desired manner, such as: 1) in writing on a paper form; 2) by an individual entering his/her own information directly into in an electronic device in response to queries generated by a software application; 3) by a third person entering information electronically upon oral queries to the person; and/or 4) by a third person entering information electronically based on a written form completed by the person. The information is entered via a user interface comprising a cell phone, smart phone, tablet personal computer, laptop computer, notebook computer and/or personal computer. The INDI code and associated data is then uploaded to servers and stored for later access and retrieval. A first set of mappings correlate each of the predetermined life statistics with a coded representation for the life statistic. A second set of mappings correlate the coded representation with one of a series of linear positions within the INDI. The graphics generator prepares a presentation of the global identity code according to the life statistics as coded and correlated to the linear positions selected by the second set of mappings.

Where the life statistics comprise data regarding the person's birth place or residence location, the first set of mappings may comprise: 1) a translation of the residence data into residence coordinates comprising a latitudinal coordinate, on the one hand, and a longitudinal coordinate, on the other hand; 2) a calculation comparing the residence coordinates against a set of airport center coordinates; 3) a determination of an airport center coordinate in closest proximity to the residence coordinates; 4) assignment of the corresponding ICAO code closest to the residence coordinates.

The life statistics are stored in an electronic format. Each section (containing one or more life statistics) is stored separately. Alternately, each life statistic is stored separately. The life statistic data may be stored virtually in a cloud computing format. The data may then be retrieved and reassembled with the appropriate authentication using the INDI code. As a result, the life statistic data may be downloaded to multiple servers in different parts of the world. The data may then be retrieved and reassembled using the INDI code to search the stored coded data for codes matching the sequence of the INDI number. As the INDI number code is searched from Section 1 to Section 10, a match will be found for a particular individual's saved data. The separation of the saved life statistic data ensures privacy and allows for retention of the data over the internet. No centralized database is required.

### F. OTHER EMBODIMENTS

It should be understood that various modifications within the scope of this invention can be made by one of ordinary skill in the art without departing from the spirit thereof and without undue experimentation. Significantly, the INDI code is scalable to fewer or more sections, where appropriate, depending on the amount of field identifier information available. Where limited information is available, the reduced amount of information may be represented by field sections that are left blank or filled with zeros. Conversely, unlimited additional information, such as a complete genetic code, may be incorporated into and/or linked to one or more sections within an INDI, thereby expanding the amount of information for that section. The system may further be utilized in conjunction with radio-frequency identification technology and global positioning system technology for confirmation of an individual's location and tracking.

In addition, the use of personalized coded information may be re-ordered, extended and/or simplified. The coded information may be represented by numerals, letters, symbols or a combination thereof; the information may be converted into a bar code; and/or may be represented electronically in any suitable or desired manner. This invention is therefore to be defined by the scope of the disclosure herein as broadly as the prior art will permit, and in view of the specification if need be, including a full range of current and future equivalents thereof.

### G. INDUSTRIAL APPLICABILITY

It is clear that the inventive System for International Alpha-Numeric Demographic Identity Code of this application has wide applicability to any industry, government entity, and/or non-governmental organization seeking to identify persons. The present invention provides a unique global identity for every human on the earth, regardless of background or nationality. The code may be maintained both electronically and on paper. The code may be encrypted and/or biometrically protected for security purposes. The INDI disclosed in this application may be utilized within the health care industry as a global patient identification number to access electronic medical records. The INDI may further or alternately be used in any desired or suitable commercial or non-commercial setting for any identification purposes.

The INDI is a unique identifier. It contains both letters and numerals representing coded information in a prescribed order read from left to right. The alpha-numeric code may be linked to a person's data biometrically through use of a fingerprint, or simply by taking a photograph of the person, such as a photograph taken on a cell phone camera. When accessed by the patient's fingerprint, the INDI appears in a non-sequential, random order until a password is entered. In case of an emergency, the password protection can be overridden with permission of an administrator.

In the field of medicine, any health care worker involved in the management of a patient may use the INDI to access and update a patient's health record. The updated information becomes part of the record and can be accessed, in the future, by other practitioners. Modalities, such as vaccine delivery, specific malaria, anti-TB, or HIV antiretroviral therapies, or the tracking of patients and their outcomes become accessible and fluid across international barriers, institutions and clinics.

I claim:

1. An apparatus for generation and display of a unique global identity code for a human comprising:
a user interface to receive data about the human including information regarding a set of life statistics;
a first set of mappings correlating each of the life statistics of the human with a coded representation for the life statistic;
a second set of mappings correlating the coded representation with one of a series of linear positions within the global identity code;
a graphics generator to prepare a presentation of the global identity code according to the life statistics as coded and correlated to the linear positions selected by the second set of mappings.

2. The apparatus of claim 1, wherein the user interface comprises a device selected from the group consisting of: cell phone, smart phone, tablet personal computer, laptop computer, notebook computer, personal computer.

3. The apparatus of claim 1, wherein the life statistics comprise a set of static statistics combined with a set of dynamic statistics.

4. The apparatus of claim 1, wherein the unique global identity code comprises a biometric signature for the human.

5. The apparatus of claim 1, wherein the information regarding a life statistic is expanded.

6. The apparatus of claim 1, wherein the information regarding a life statistic is reduced.

7. The apparatus of claim 1, wherein the life statistics comprise one or more of the following: a current name, a sexual identity, a date of birth, a country of birth, a place of birth, a maiden name of a birth mother, a name at birth, an ethnic classification, a tribal classification, a blood type, an occupation, a country of residence, a location of residence, a country of death, a date of death.

8. The apparatus of claim 1, wherein the coded representation comprises a code formed from the group consisting of: letters, numbers, letters and numbers.

9. The apparatus of claim 1, wherein the coded representation comprises an ethnic classification, said classification comprising a first letter from the ethnic classification of a mother of the human, and a second letter from the ethnic classification of a father of the human.

10. The apparatus of claim 1, wherein the life statistics comprise data regarding a country and place of birth for the human, a coded representation of said data comprising International Civil Aviation Organization codes.

11. The apparatus of claim 1, wherein the life statistics comprise data regarding a country and place of residence for the human, a coded representation of said data comprising International Civil Aviation Organization codes.

12. The apparatus of claim 1, wherein the life statistics comprise data regarding the human's residence location, and the first set of mappings comprise:
a translation of the residence data into residence coordinates comprising a latitudinal coordinate, on the one hand, and a longitudinal coordinate, on the other hand;
a calculation comparing the residence coordinates against a set of airport center coordinates;
a determination of an airport center coordinate in closest proximity to the residence coordinates; and,
an assignment of a corresponding International Civil Aviation Organization code closest to the residence coordinates.

13. The apparatus of claim 1, wherein the linear positions number ten.

14. The apparatus of claim 1, wherein the graphic presentation is an alphanumeric string read from left to right.

15. The apparatus of claim 1, wherein the graphic presentation is a two-dimensional barcode.

16. The apparatus of claim 1, further comprising a security measure selected from the group consisting of: symmetric cryptography with password access, symmetric cryptography with biometric access, asymmetric cryptography with password access, asymmetric cryptography with biometric access, hashing with password access, hashing with biometric access, fingerprint biometric identification, iris biometric identification, retina biometric identification, finger geometry biometric identification, voice biometric identification, facial proportion biometric identification, hand geometry biometric identification.

17. A computer implemented method of generating and displaying a unique global identity code for a human, comprising operations of:
providing a user interface and receiving data about the human including information regarding life statistics;
receiving a first set of mappings correlating each of the life statistics of the human with a coded representation for the life statistic;
receiving a second set of mappings correlating the coded representation with one of a series of linear positions within the global identity code;
operating a graphics generator to prepare a presentation of the global identity code according to the life statistics as coded and correlated to the linear positions selected by the second set of mappings.

18. The method of claim 17, further comprising the step of securing the code by a security measure selected from the group consisting of: symmetric cryptography with password access, symmetric cryptography with biometric access, asymmetric cryptography with password access, asymmetric cryptography with biometric access, hashing with password access, hashing with biometric access, fingerprint biometric identification, iris biometric identification, retina biometric identification, finger geometry biometric identification, voice biometric identification, facial proportion biometric identification, hand geometry biometric identification.

19. A computer readable storage media containing a program to generate and display a unique global identity code for a human, the operations comprising:
providing a user interface and receiving data about the human including information regarding life statistics;
receiving a first set of mappings correlating each of the life statistics of the human with a coded representation for the life statistic;
receiving a second set of mappings correlating the coded representation with one of a series of linear positions within the global identity code;
operating a graphics generator to prepare a presentation of the global identity code according to the life statistics as coded and correlated to the linear positions selected by the second set of mappings.
